(19) United States
(12) Patent Application Publication
(10) Pub. No.: US 2025/0238061 A1
(43) Pub. Date: Jul. 24, 2025

(54) METHODS AND SYSTEMS FOR PROVIDING ELECTRIC POWER TO ELECTRONIC DEVICES IN A SURGICAL ENVIRONMENT

(71) Applicant: Stryker Corporation, Portage, MI (US)

(72) Inventors: Neel MISTRY, Haslet, TX (US); Eric Alexander HEREFORD, North Richland Hills, TX (US)

(73) Assignee: Stryker Corporation, Portage, MI (US)

(21) Appl. No.: 19/033,281

(22) Filed: Jan. 21, 2025

Related U.S. Application Data
(60) Provisional application No. 63/623,725, filed on Jan. 22, 2024.

(51) Int. Cl. G06F 1/26; G06F 1/16; G06F 1/18; G06F 1/28; G06F 1/30

(52) U.S. Cl. CPC G06F 1/266; G06F 1/1688; G06F 1/1698; G06F 1/182; G06F 1/189; G06F 1/28; G06F 1/30

(57) ABSTRACT

An exemplary device for providing power to a plurality of electronic devices in a surgical environment and for processing multimedia data associated with the surgical environment, comprises: a housing; a plurality of ports exposed on the housing, each port connectable to an electronic device of the plurality of electronic devices in the surgical environment; a first power unit comprising a first power supply and a power distribution unit, wherein the power distribution unit is configured to receive power from the first power supply and distribute the power across the plurality of ports; an audio output port exposed on the housing; a transceiver configured to receive and decode a multimedia signal associated with the surgical environment; an audio amplifier configured to amplify the decoded multimedia signal and output the decoded and amplified multimedia signal via the audio output port; and a second power unit configured to power the audio amplifier.

### CROSS-REFERENCE TO RELATED APPLICATION

This application claims the benefit of U.S. Provisional Application 63/623,725 filed on Jan. 22, 2024, the entire content of which is incorporated herein by reference for all purposes.

### FIELD

The present disclosure relates to providing electric power to electronic devices in a surgical environment and processing multimedia data associated with the surgical environment in a space-efficient, safe, and robust manner.

### BACKGROUND

A surgical environment (e.g., an operating room) can include many electronic devices for supporting and aiding surgical procedures, such as cameras, medical devices, surgical tools, displays, speakers, input devices, video or audio encoders, video or audio decoders, transceivers, or any combination thereof. Some of the electronic devices can be connected to a network, such that the electronic devices can transmit data through the network and/or receive data from the network.

A power solution is needed to provide electric power to the electronic devices in the surgical environment. While each electronic device may include a dedicated power brick for connecting the electronic device with a power source, powering the various electronic devices in the surgical environment using separate power bricks can be deficient for several reasons. The multitude of power bricks can take up a large amount of space in the surgical environment. The power bricks can collectively generate a high level of heat, making it more difficult to maintain a desirable temperature in the surgical environment. Further, because the various electronic devices may be distributed across different locations in the surgical environment, the corresponding power bricks can be difficult to install and wire while maintaining compliance with the various building codes associated with the surgical environment, such as NEC Class 2 (pertaining to the design and installation of power circuits that are limited in power output to reduce the risk of fire and electrical shock).

Further, the surgical environment can require one or more devices for providing multimedia processing capabilities (e.g., for providing audio or video playback, for playing music or videos, for processing voice commands). Currently, the device(s) for providing electric power and the device(s) for processing multimedia data are often separate devices, thus requiring more storage space. Further, as these devices are distributed across the surgical environment, the requisite wiring can be complex and difficult to set up and maintain in the surgical environment.

### SUMMARY

Disclosed herein are exemplary power devices for providing electric power to a plurality of electronic devices in a surgical environment and for processing multimedia data associated with the surgical environment. By providing power for multiple electronic devices and multimedia processing capabilities in single power device, the power device provides a space-efficient solution and a simplified wiring configuration, which are particularly advantageous in surgical environments where adequate space for electronic devices is often limited. An exemplary power device can comprise a housing. A plurality of power ports and an audio output port can be exposed on the housing. Each power port can be connectable to an electronic device of a plurality of electronic devices in the surgical environment, and the audio output port can be connected to one or more audio devices (e.g., one or more speakers) to output processed audio data.

The housing of the power device encloses various components. Specifically, the housing of the power device can enclose a first power unit including a first power supply and a power distribution unit. The power distribution unit is configured to receive power from the first power supply and distribute the power across the plurality of power ports. The housing further encloses a transceiver configured to receive and decode an audio signal associated with the surgical environment and an audio amplifier configured to amplify the decoded audio signal and output the decoded and amplified audio signal via the audio output port. The audio amplifier can be separately powered using a second power unit enclosed in the housing. As described herein, a power unit may comprise a single component or multiple components.

The power device as described herein provides numerous technical advantages. For example, the power device eliminates the need to provide two devices, one dedicated to providing power and one dedicated to processing multimedia data. Instead, the power device is a device having a single housing that can both power the various electronic devices in a surgical environment and process multimedia data associated with the surgical environment in compliance with the NEC Class 2 requirements. Thus, the power device provides a space-efficient solution, which is particularly advantageous in surgical environments where adequate space for electronic devices is often limited.

The power device can be installed on an information technology (IT) rack, which is a supporting frame that holds hardware modules. In some examples, the power device can reduce the space traditionally required to hold multiple devices providing the same functionalities on the IT rack by 75%. Furthermore, a single cord can be used to connect the power device with a power outlet. The IT rack can be placed inside the surgical environment (e.g., an operating room) or near the surgical environment (e.g., in a room adjacent to the operating room). The power device can be faster to install and wire than multiple separate devices, allowing the medical practitioners to access and use the surgical environment sooner.

Advantageously, the power device can include two separate power units. A first power unit can distribute and provide power to the electronic devices in the surgical environment, while a second power unit can provide power to the audio amplifier. The separate power units can help to reduce crosstalk (e.g., switching noise from stepping down or up voltages) and ensure integrity of the multimedia signals such as audio signals.

Advantageously, the power device can include a number of heat dissipation mechanisms. For example, the power device can include a number of fan modules to draw ambient air into the housing through a front panel, as well as a number of dividers (e.g., metal baffles, plastic baffles, etc.) enclosed in the housing to ensure that the incoming air is circulated within the housing in accordance with predefined paths to maximize the dissipation of heat. After circulating within the housing, the air exits through the back panel. The front-to-back airflow configuration is advantageous because the configuration draws cooler air from the surgical environment (e.g., an operating room) into the housing and exhausts the circulated air through the back panel, which faces away from the surgical environment, to avoid introduction of contamination into the surgical environment by the circulated air. In some examples, a divider can serve multiple functions, both directing air flow for heat dissipation and providing insulation (e.g., Electromagnetic Radiation (EMR) insulation, audio insulation, or the like) between various components in the housing.

Advantageously, the power device can include a number of communication links to allow the transceiver to receive control signals over a network and send the control signals to control various components of the power device, such as the power distribution unit and the audio amplifier. Accordingly, the transceiver allows a user to configure and/or control the various components of the power device remotely through a communication network. For example, the user can input one or more user commands for the various components of the power device via a central device and the central device can transmit control signals to the transceiver accordingly to control the various components for the power device. In some examples, the central device may be in an easier-to-access location than the power device.

Advantageously, the power device can provide a robust mechanism for managing momentary short circuit(s) detected at one of the power ports of the device. A robust mechanism for managing momentary short circuit(s) can be beneficial, for example, during the installation process. Without a robust mechanism for managing momentary short circuit(s), any short circuit detected at a power port of the power device would automatically disable or turn off the power port and/or the power device. The user then would typically have to return to the IT rack on which the power device is located and manually re-enable or turn on the power port and/or the power device. This is a cumbersome process, especially because the user may need to go back and forth between the electronic devices in the surgical environment and the power device (which may be located in a different room) as he or she connects the electronic devices in the surgical environment one-by-one during the installation process. As described herein, the power device can, upon detecting a short circuit, perform a number of retries before disabling a power port, thus allowing time for the user to resolve the momentary short circuit without having to manually re-enable disabled power ports.

Advantageously, the power device can provide a fail-safe mechanism to ensure that the power ports are operational (e.g., provide power) even in the event of a boot failure of the microcontroller of the power device. The fail-safe mechanism is beneficial because the power device provides power to critical devices (e.g., cameras, displays, surgical tools) in a surgical environment and needs to continue providing power even in the event of the boot failure of the microcontroller to ensure patient safety.

An exemplary device for providing power to a plurality of electronic devices in a surgical environment and for processing multimedia data associated with the surgical environment comprises: a housing; a plurality of ports exposed on the housing, each port connectable to an electronic device of the plurality of electronic devices in the surgical environment; a first power unit enclosed in the housing, the first power unit comprising a first power supply and a power distribution unit, wherein the power distribution unit is configured to receive power from the first power supply and distribute the power across the plurality of ports; an audio output port exposed on the housing; a transceiver enclosed in the housing, wherein the transceiver is configured to receive and decode an audio signal associated with the surgical environment; an audio amplifier enclosed in the housing, wherein the audio amplifier is configured to amplify the decoded audio signal and output the decoded and amplified audio signal via the audio output port; and a second power unit enclosed in the housing, wherein the second power unit is different from the first power unit and is configured to power the audio amplifier.

In some aspects, the plurality of electronic devices in the surgical environment comprise: one or more cameras, one or more medical devices, one or more surgical tools, one or more displays, one or more speakers, one or more input devices, one or more video or audio encoders, one or more video or audio decoders, one or more transceivers, or any combination thereof.

In some aspects, the device further comprises a first divider enclosed in the housing, wherein the first divider extends from a side panel of the housing to a back panel of the housing to form a compartment, and wherein the first power unit is disposed outside the compartment and the second power unit is disposed inside the compartment.

In some aspects, the first divider is configured to direct a first air flow to enter from the front panel of the housing, to circulate through the second power unit disposed inside the compartment, and to exit through the back panel of the housing.

In some aspects, the first divider is configured to direct a second air flow to enter from a front panel of the housing, to circulate through the first power unit disposed outside the compartment, and to exit through the back panel of the housing. In some aspects, the first divider is configured to provide Electromagnetic Radiation (EMR) insulation between the first power unit and the second power unit.

In some aspects, the device further comprises a second divider enclosed in the housing, wherein the second divider extends between at least a portion of the power distribution unit and at least a portion of the first power supply to direct air circulating through the power distribution unit away from the first power supply.

In some aspects, the transceiver is configurable to: encode and transmit a first plurality of data associated with the surgical environment; and receive and decode a second plurality of data associated with the surgical environment. In some aspects, the second power unit is dedicated to provide power to the audio amplifier.

In some aspects, the device further comprises a first communication link between the transceiver and the first power unit. In some aspects, the transceiver is configured to receive a first control signal for the first power unit and provide the first control signal for the first power unit to the first power unit via the first communication link.

In some aspects, the device further comprises a second communication link between the transceiver and the audio amplifier. In some aspects, the transceiver is configured to receive a second control signal for the audio amplifier and provide the second control signal for the audio amplifier to the audio amplifier via the second communication link.

In some aspects, the first power unit is further configured to: (a) detect a short circuit at a port of the plurality of ports; (b) upon detecting the short circuit, disable the port for a predefined time period; and (c) enable the port after the predefined time period.

In some aspects, the first power unit is further configured to: repeat steps (a)-(c) for a predefined number of iterations; and disable the port if the short circuit is detected at the port in each iteration of the predefined number of iterations.

In some aspects, the first power unit comprises a microcontroller and is further configured to: upon receiving power, boot the microcontroller; identify a failed boot of the microcontroller; and automatically enable the plurality of ports.

In some aspects, the plurality of ports are automatically enabled via a one-shot circuit.

In some aspects, the first power unit is further configured to: identify a successful boot of the microcontroller, and enable the plurality of ports based on a previous state of each port of the plurality of ports.

An exemplary method for providing power to a plurality of electronic devices in a surgical environment and for processing multimedia data associated with the surgical environment, comprises: at a power device: receiving, by a power distribution unit enclosed in a housing of the power device, power from a first power supply enclosed in the housing of the power device; distributing, by the power distribution unit, the power across a plurality of ports exposed on the housing, wherein each port of the plurality of ports is connectable to an electronic device of the plurality of electronic devices in the surgical environment; receiving and decoding, by a transceiver enclosed in the housing, an audio signal associated with the surgical environment; amplifying, by an audio amplifier enclosed in the housing and powered by a second power supply different from the first power supply, the decoded audio signal; outputting the decoded and amplified audio signal via an audio output port exposed on the housing of the power device.

An exemplary non-transitory computer-readable storage medium stores one or more programs for providing power to a plurality of electronic devices in a surgical environment and for processing multimedia data associated with the surgical environment, the one or more programs comprising instructions, which when executed by one or more processors of a power device, cause the power device to: receiving, by a power distribution unit enclosed in a housing of the power device, power from a first power supply enclosed in the housing of the power device; distributing, by the power distribution unit, the power across a plurality of ports exposed on the housing, wherein each port of the plurality of ports is connectable to an electronic device of the plurality of electronic devices in the surgical environment; receiving and decoding, by a transceiver enclosed in the housing, an audio signal associated with the surgical environment; amplifying, by an audio amplifier enclosed in the housing and powered by a second power supply different from the first power supply, the decoded audio signal; outputting the decoded and amplified audio signal via an audio output port exposed on the housing of the power device.

It will be appreciated that any of the variations, aspects, features and options described in view of the systems apply equally to the methods and vice versa. It will also be clear that any one or more of the above variations, aspects, features and options can be combined.

### BRIEF DESCRIPTION OF THE FIGURES

The invention will now be described, by way of example only, with reference to the accompanying drawings, in which:

FIG. 1 illustrates an exemplary system comprising a plurality of electronic devices in a surgical environment.

FIG. 2A illustrates an exemplary power device for providing power to a plurality of electronic devices in a surgical environment and for processing multimedia data associated with the surgical environment.

FIG. 2B illustrates an exemplary front panel of the power device.

FIG. 2C illustrates an exemplary back panel of the power device.

FIG. 3 illustrates an exemplary diagram showing transmission of electric power and data signals by the power device.

FIG. 4 illustrates an exemplary process for detecting and responding to a short circuit.

FIG. 5 illustrates an exemplary startup process of the power device.

FIG. 6 illustrates an exemplary electronic device, in accordance with some examples.

### DETAILED DESCRIPTION

Reference will now be made in detail to implementations and examples of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Disclosed herein are exemplary power devices for providing electric power to a plurality of electronic devices in a surgical environment and for processing multimedia data associated with the surgical environment. By providing power for multiple electronic devices and multimedia processing capabilities in single power device, the power device provides a space-efficient solution and a simplified wiring configuration, which are particularly advantageous in surgical environments where adequate space for electronic devices is often limited. An exemplary power device can comprise a housing. A plurality of power ports and an audio output port can be exposed on the housing. Each power port can be connectable to an electronic device of a plurality of electronic devices in the surgical environment, and the audio output port can be connected to one or more audio devices (e.g., one or more speakers) to output processed audio data.

The housing of the power device encloses various components. Specifically, the housing of the power device can enclose a first power unit including a first power supply and a power distribution unit. The power distribution unit is configured to receive power from the first power supply and distribute the power across the plurality of power ports. The housing further encloses a transceiver configured to receive and decode an audio signal associated with the surgical environment and an audio amplifier configured to amplify the decoded audio signal and output the decoded and amplified audio signal via the audio output port. The audio amplifier can be separately powered using a second power unit enclosed in the housing. As described herein, a power unit may comprise a single component or multiple components.

The power device as described herein provides numerous technical advantages. For example, the power device eliminates the need to provide two devices, one dedicated to providing power and one dedicated to processing multimedia data. Instead, the power device is a device having a single housing that can both power the various electronic devices in a surgical environment and process multimedia data associated with the surgical environment in compliance with the NEC Class 2 requirements. Thus, the power device provides a space-efficient solution, which is particularly advantageous in surgical environments where adequate space for electronic devices is often limited.

The power device can be installed on an information technology (IT) rack, which is a supporting frame that holds hardware modules. In some examples, the power device can reduce the space traditionally required to hold multiple devices providing the same functionalities on the IT rack by 75%. Furthermore, a single cord can be used to connect the power device with a power outlet. The IT rack can be placed inside the surgical environment (e.g., an operating room) or near the surgical environment (e.g., in a room adjacent to the operating room). The power device can be faster to install and wire than multiple separate devices, allowing the medical practitioners to access and use the surgical environment sooner.

Advantageously, the power device can include two separate power units. A first power unit can distribute and provide power to the electronic devices in the surgical environment, while a second power unit can provide power to the audio amplifier. The separate power units can help to reduce crosstalk (e.g., switching noise from stepping down or up voltages) and ensure integrity of the multimedia signals such as audio signals.

Advantageously, the power device can include a number of heat dissipation mechanisms. For example, the power device can include a number of fan modules to draw ambient air into the housing through a front panel, as well as a number of dividers (e.g., metal baffles, plastic baffles, etc.) enclosed in the housing to ensure that the incoming air is circulated within the housing in accordance with predefined paths to maximize the dissipation of heat. After circulating within the housing, the air exits through the back panel. The front-to-back airflow configuration is advantageous because the configuration draws cooler air from the surgical environment (e.g., an operating room) into the housing and exhausts the circulated air through the back panel, which faces away from the surgical environment, to avoid introduction of contamination into the surgical environment by the circulated air. In some examples, a divider can serve multiple functions, both directing air flow for heat dissipation and providing insulation (e.g., Electromagnetic Radiation (EMR) insulation, audio insulation, or the like) between various components in the housing.

Advantageously, the power device can include a number of communication links to allow the transceiver to receive control signals over a network and send the control signals to control various components of the power device, such as the power distribution unit and the audio amplifier. Accordingly, the transceiver allows a user to configure and/or control the various components of the power device remotely through a communication network. For example, the user can input one or more user commands for the various components of the power device via a central device and the central device can transmit control signals to the transceiver accordingly to control the various components for the power device. In some examples, the central device may be in an easier-to-access location than the power device.

Advantageously, the power device can provide a robust mechanism for managing momentary short circuit(s) detected at one of the power ports of the device. A robust mechanism for managing momentary short circuit(s) can be beneficial, for example, during the installation process. Without a robust mechanism for managing momentary short circuit(s), any short circuit detected at a power port of the power device would automatically disable or turn off the power port and/or the power device. The user then would typically have to return to the IT rack on which the power device is located and manually re-enable or turn on the power port and/or the power device. This is a cumbersome process, especially because the user may need to go back and forth between the electronic devices in the surgical environment and the power device (which may be located in a different room) as he or she connects the electronic devices in the surgical environment one-by-one during the installation process. As described herein, the power device can, upon detecting a short circuit, perform a number of retries before disabling a power port, thus allowing time for the user to resolve the momentary short circuit without having to manually re-enable disabled power ports.

Advantageously, the power device can provide a fail-safe mechanism to ensure that the power ports are operational (e.g., provide power) even in the event of a boot failure of the microcontroller of the power device. The fail-safe mechanism is beneficial because the power device provides power to critical devices (e.g., cameras, displays, surgical tools) in a surgical environment and needs to continue providing power even in the event of the boot failure of the microcontroller to ensure patient safety.

In the following description, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating,” or the like refer to the action and processes of a computer system, or similar electronic computing device, that manipulates and transforms data represented as physical (electronic) quantities within the computer system memories or registers or other such information storage, transmission, or display devices.

The present disclosure in some examples also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMS, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein.

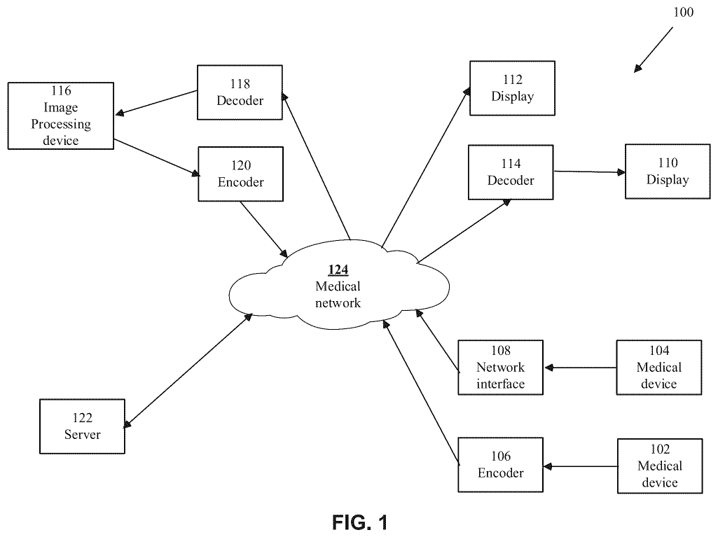

FIG. 1 illustrates an example system 100 including a plurality of electronic devices. The example system 100 may operate in a surgical environment and may include various devices that users (e.g., surgeons, medical staff, and the like) operate during a medical procedure. The various devices may either generate various data (i.e., the devices are data sources such as a medical imaging system or component thereof), receive various data (i.e., the devices are data sinks such as display equipment), or both (i.e., the devices are both data sources and data sinks). The various devices may be connected to a medical network 124 such that different kinds of data (such as video data, image data, audio data, measurement data, control data, among many others) from the data sources may be transmitted to the data sinks. The medical network 124 may be limited in range to cover a specific area, such as the medical room environment, but not extend beyond that. As such, the medical network 124 may be any appropriate type of network with a limited range, such as a local area network (LAN), virtual local area network (VLAN), or a Wireless Fidelity (WiFi) network.

Referring to FIG. 1, the system 100 may include a medical device 102. Medical device 102 may be any medical device that generates data, such as a medical imaging system or component thereof (for example, a C-arm fluoroscopic imager or an endoscopic imager) or may be any medical device that includes components for generating data, such as surgical light that includes an in-light camera. As such, medical device 102 is considered herein as a data source. The medical device 102 may be connected to an encoder 106 that takes the data in a native format (which may also be referred to as native data) generated by the medical device 102 and converts that data to a format that can be transmitted through the medical network 124. The format that the encoder 106 converts the data to any appropriate format that allows the converted data to be transmitted through the medical network. For example, the encoder 106 may convert the data from the native format to a series of packets that each include additional network transmission metadata, such as multicast addresses. Specifically, the encoder 106 may convert the data from the native format to a packetized form according to the communication protocol used by the interoperable medical devices connected to the medical network 124, such as the Internet Protocol (IP) including the Transmission Control Protocol (TCP) and the User Datagram Protocol (UDP). In such cases, the encoder 106 may convert the native video data to IP packets that are then transmitted through the medical network 124.

While the medical device 102 may be connected to encoder 106 which may be a separate component from the medical device 102, the system 100 may include a medical device 104 that has an integrated encoder which is part of the medical device 104. As a result, conversion of the native data to the packetized format for transmission through the medical network 124 may be performed by the integrated encoder of the medical device 104. Similar to medical device 102, medical device 104 may be any medical device that generates data or any medical device that includes components for generating data.

It may also be noted that the medical devices 102 and 104 of system 100 may include any device that is present in the surgical environment that generates data that is transmitted through the medical network 124. Thus, for example, either of medical devices 102 and 104 may be a pan-tilt-zoom (PTZ) camera. While a PTZ camera may be used to generate additional medically relevant data, it may also be used to generate non-medical data, such as a video stream of the medical room. In either case, the data generated from the PTZ camera (which may be still images, video, and/or audio data) may be sent to an encoder to be converted from a native format to a packetized format that is able to be transmitted through the medical network 124. For example, the PTZ camera may produce data in a packetized format and the encoder may convert from one packetized format to another packetized format that is compatible for transport over the medical network 124. Alternatively, either of the medical devices 102 and 104 may be a keyboard, video, and mouse (KVM) source. A KVM source may be a workstation in the medical room environment that allows users (e.g., surgeons, medical staff, and the like) to control the various other devices in the medical room for a variety of purposes. For example, a camera may lose focus, but instead of directly adjusting the focus, which may compromise sterilization, the focus may be restored through the KVM source remotely. The data generated by the medical devices 102 and 104 may thus also be a variety of commands. The command data may then be sent to an encoder to be converted to a packetized format for transmission through the medical network 124.

After the native data from the medical devices 102 and 104 has been converted to a packetized format, the converted data may be transmitted through the medical network 124. Encoder 106 may include a network interface for transmitting data through the medical network 124. The medical device 104 can communicate with the medical network 124 via the network interface 108. The network interface 108 may be an integrated component of the medical device 104 or may be a separate component. The network interface 108 may be any appropriate component that is able to establish a connection to the medical network 124, which may depend on what type of network is used for medical network 124. For example, if the medical network 124 is a wired network, the network interface 108 may be configured to transmit data on the wired network. Alternatively, if the medical network 124 is a WiFi network, the network interface 108 may include a transceiver that generates and receives radio waves.

In addition to the data source devices described so far, the system 100 may also include various data sink devices. For example, the medical room environment may include displays 110 and 112 for displaying various types of data, such as user interfaces, images, and/or video feeds generated by one or more of the data sources, such as any combination of medical devices 102, 104, and 116 which is described further herein. The data source that the displays 110 and 112 receive data from may also be adjusted as necessary by the users (e.g., surgeons, medical staff, and the like) in the medical room environment. The display 110 may be configured to process data in a native format, which may correspond to the native format of the data generated by medical devices 102 and 104 or may be a different native format, but in either case, may differ from the packetized format that is used when transmitting data through the medical network 124. As such, the display 110 may be connected to a decoder 114 that converts the packetized data from the medical network 124 to the native format supported by the display 110, which may be a sequence of binary bits. On the other hand, the display 112 may have an integrated decoder as part of the display, and thus may not be connected to a separate decoder. Similar to the medical devices 102 and 104, the displays 110 and 112 may be associated with network interfaces that connect to the medical network 124 and receive data. A first network interface may be integrated into decoder 114, allowing the decoder 114 to connect to the medical network 124 and receive data. Alternatively, display 112 itself may include an integrated network interface, allowing the display 112 to connect to the medical network 124 and receive data. In this case, display 112 may include both an integrated decoder and an integrated network interface. However, the network interface may also be a separate component from either or both a decoder and the decoder's corresponding display. The displays 110 and 112 may also be any device capable of receiving data, which may include but is not limited to a recorder, a speaker, a printer, a monitor, a projector, a headset, or a USB extension hub, among many others.

The system 100 may also include an image processing device 116, which may transmit and receive data through the medical network 124 and may thus be a data source and data sink. In some examples, the image processing device 116 includes a camera control unit (CCU). Similar to the display 110, the image processing device 116 may be connected to a decoder 118 that converts the data from a packetized format to a native format supported by the image processing device 116. The decoder 118 may include an integrated network interface that allows the decoder 118 to connect to the medical network 124 and receive data. The image processing device 116 may also be connected to an encoder 120 that converts the data from a native format to a packetized format for transmission through the medical network 124, similar to the medical device 102. The encoder 120 may also include an integrated network interface that allows the encoder 120 to connect to the medical network 124 and transmit data. The image processing device 116 may be configured to process the data from a data source, such as by modifying the resolution in imaging or video data, before the data is received by a data sink. For example, medical device 102 may generate video data that is converted by encoder 106 and transmitted through the medical network 124. That data may then be received at decoder 118 and converted to a native format for the image processing device 116. The image processing device 116 may then process the video data generated by the medical device 102 before the encoder 120 converts the processed data and transmits it through the network 124. The processed data may then finally be received by display 110 through the decoder 114. The image processing device 116, as well as one or more of the medical devices 102, 104, 110, and 112, may also be connected to a series of control cables that may allow the image processing device 116 to be remotely controlled, either from the same environment in which the image processing device 116 is located or from another separate location. The medical devices 102, 104, 110, 112 and/or the image processing device 116 may also be controlled through information or commands that are transmitted across the medical network 124, instead of or in addition to a series of control cables.

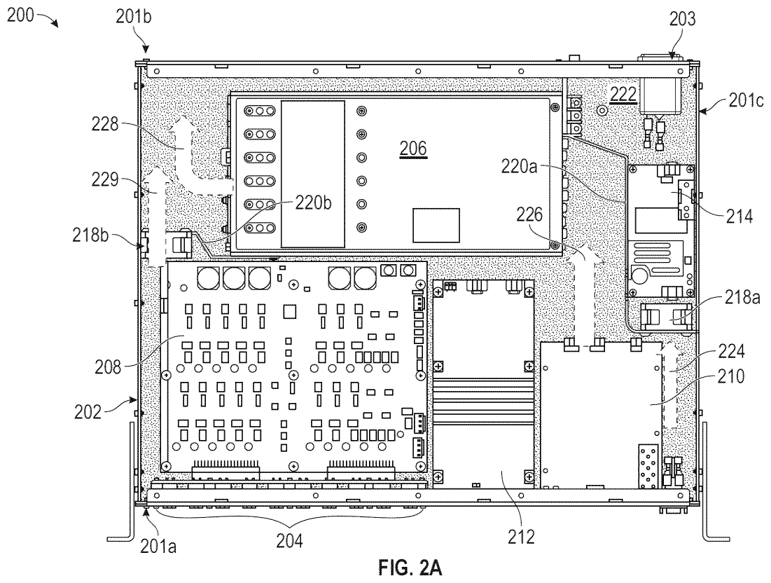

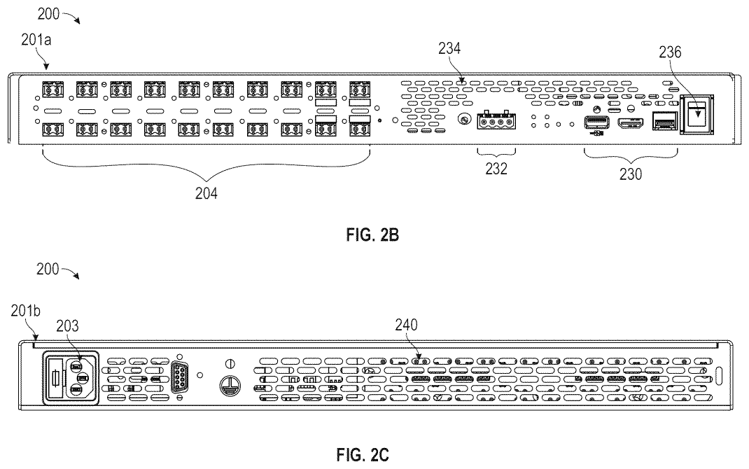

FIG. 2A illustrates an exemplary power device 200 for providing electric power to a plurality of electronic devices in a surgical environment and for processing multimedia data (e.g., audio data, video data) associated with the surgical environment. The plurality of electronic devices in the surgical environment that can be powered by the power device 200 can comprise any electronic device used to support and/or aid surgical procedures, such as one or more cameras, one or more medical devices, one or more surgical tools, one or more displays, one or more speakers, one or more input devices, one or more video or audio encoders, one or more video or audio decoders, one or more transceivers, or any combination thereof. The plurality of electronic devices can be distributed throughout the surgical environment. In some examples, some of the plurality of electronic devices can be co-located proximal to video sources and sinks.

With reference to FIG. 2A, the power device 200 includes a power inlet 203. The power inlet 203 can be connected to a power source (e.g., a power outlet) via a cable to receive electric power from the power source. The power device 200 can then provide the received electric power to various power supplies of the power device 200 to drive other components of the power device 200, as described below. In some examples, the power inlet 203 is an Alternating Current (AC) power inlet that can be connected to the power source via an external AC power cord to receive AC power.

The power device 200 includes a housing 202 enclosing various components of the power device 200. The housing 202 comprises a front panel 201a that exposes a plurality of power ports 204. Each power port of the plurality of power ports 204 is connectable to an electronic device in the surgical environment to supply power to the connected electronic device. The plurality of power ports 204 are powered by a first power unit enclosed in the housing 202. The first power unit can comprise one or multiple hardware components. In the depicted example, the first power unit includes a first power supply 206 and a power distribution unit 208. However, it should be appreciated by one of ordinary skill in the art that the first power supply 206 and the power distribution unit 208 may be combined as a single hardware unit.

The first power supply 206 can receive electric power (e.g., AC power) from the power inlet 203. In some examples, the first power supply 206 is an AC/DC power supply that converts the incoming AC power to a stable direct current (DC) power output. The first power supply 206 can provide electric power to the power distribution unit 208. In some examples, the first power supply 206 can provide DC power to the power distribution unit 208. The power distribution unit 208 can then distribute the power (e.g., DC power) across a plurality of power ports 204. In some examples, the power distribution unit 208 steps the received DC power down to a lower voltage (e.g., 24 volts for each port). In some examples, the power distribution unit 208 includes a built-in electronic fuse (E-fuse) for detecting and quickly reacting to overcurrent and overvoltage conditions.

In some examples, the plurality of power ports 204 may be configured to output different levels of power. For example, the plurality of power ports 204 can comprise 20 individual DC power ports for supplying DC power, including 4 DC ports configured to output 80 watts (e.g., optimized for powering electronic devices such as touch panels and USB extensions) and 16 DC power ports configured to output 30 watts. In some examples, each individual power port of the plurality of power ports 204 has a built-in E-fuse for detecting and quickly reacting to overcurrent and overvoltage conditions. For example, on a single-fault condition or in a short-circuit condition, each individual power port can be configured to never exceed a maximum power level (e.g., 100 watts) in accordance with the NEC Class 2 requirements.

In addition to providing electric power to connected electronic devices (e.g., via the plurality of power ports 204), the power device 200 can also process and amplify audio signals associated with the surgical environment. With reference to FIG. 2A, the power device 200 further includes a transceiver 210 enclosed in the housing 202. The transceiver 210 is configured to receive and decode a data signal (e.g., an audio signal, a video signal, and the like) associated with the surgical environment, for example, via an audio input port and/or via a network. In some examples, the transceiver 210 is configurable to operate as an encoder, as a decoder, or as an encoder and a decoder simultaneously. In other words, the transceiver 210 can be configurable to encode and transmit a first plurality of data (e.g., video data) associated with the surgical environment; additionally or alternatively, the transceiver can be configurable to receive and decode a second plurality of data (e.g., audio data) associated with the surgical environment.

In some examples, the transceiver 210 is a data-over-IP transceiver (i.e., a device that transports data in accordance with Internet Protocols or IP). In some examples, the transceiver 210 can be a (Software Defined Video over Ethernet (SDVoE) transceiver. The SDVoE transceiver is configurable to encode and/or decode data (e.g., audio data, video data) for transport over a network channel (e.g., Ethernet). When operating as an encoder, the SDVoE transceiver encodes industry-standard video and/or multimedia signals into IP packets for network transport and distribution. When operating as a decoder, the SDVoE transceiver performs the decode function from IP packets to industry-standard multimedia signals. The SDVoE transceiver can provide both encode and decode functions simultaneously. The SDVoE transceiver allows for the use of standard network equipment (e.g., switches) for multimedia routing and distribution. In some examples, the transceiver 210 comprises one or more Field Programmable Gate Array (FPGA) devices. In some examples, the transceiver 210 comprises one or more Application Specific Integrated Circuit (ASIC) devices.

The power device 200 further includes an audio amplifier 212 enclosed in the housing 202. The audio amplifier 212 is configured to amplify the decoded audio signal received by the transceiver 210. The audio amplifier 212 is further configured to output the decoded and amplified audio signal via an audio output port exposed on the housing 202. The audio amplifier 212 is powered by a second power unit of the power device 200 (depicted as the second power supply 214) enclosed in the housing 202. Specifically, the second power supply 214 can receive electric power (e.g., AC power) from the power inlet 203. In some examples, the second power supply 214 is an AC/DC power supply that converts the incoming AC power to a stable DC power output to be used by the audio amplifier 212. In some examples, the second power supply 214 is dedicated to providing electric power to the audio amplifier 212 to ensure integrity of the audio signals. For example, the second power supply 214 provides power only to the audio amplifier 212 to reduce crosstalk (e.g., switching noise from stepping down or up voltages) and ensure integrity of the audio signals.

The power device 200 includes several heat dissipation mechanisms to ensure that the power device 200 operates within a desirable temperature range. In the depicted example, the power device 200 includes several fan modules to draw ambient air into the housing 202 through the front panel 201a. The power device 200 further includes several dividers (e.g., medal dividers, plastic dividers) enclosed in the housing 202 to ensure that the incoming air is circulated within the housing 202 in accordance with predefined paths to maximize the dissipation of heat. After circulating within the housing 202, the air exits through the back panel 201b. The front-to-back airflow configuration is advantageous because the configuration draws cooler air from the surgical environment (e.g., an operating room) into the housing 202 and exhausts the circulated air through the back panel 201b, which faces away from the surgical environment, to avoid introduction of contaminants into the surgical environment by the circulated air.

With reference to FIG. 2A, the power device 200 includes a first fan module 218a. The first fan module 218a is configured to draw ambient air into the housing 202 through the front panel 201a. The power device 200 further includes a first divider 220a. The first divider 220a extends from a side panel 201c of the housing 202 to the back panel 201b of the housing 202 to form a compartment 222. As shown, the first power unit (comprising the first power supply 206 and the power distribution unit 208) is disposed outside the compartment 222 and the second power unit (comprising the second power supply 214) is disposed inside the compartment 222. Accordingly, the first divider 220a directs a first air flow (as shown by arrow 224) to enter from the front panel 201a, to circulate through the second power unit (comprising the second power supply 214) disposed inside the compartment 222, and to exit through the back panel 201b. Further, the first divider 220a also directs a second air flow (as shown by arrow 226) to enter from the front panel 201a, to circulate through the first power supply 206 disposed outside the compartment 222, and to exit through the back panel 201b (as shown by arrow 228).

Accordingly, the first divider 220a serves two functions. First, the first divider 220a directs separate air flows through the first power unit (comprising the first power supply 206 and the power distribution unit 208) and the second power unit (comprising the second power supply 214), thus providing separate, and thus more effective, heat dissipation at the two power units. Second, the first divider 220a can provide insulation for electromagnetic radiation (EMR) between the two power units and/or prevent audio noise from the second power supply 214 being received by the audio amplifier 212.

With reference to FIG. 2A, the power device 200 further includes a second fan module 218b. The second fan module 218b draws in ambient air into the housing 202 via the front panel 201a and causes the incoming air (as indicated by arrow 229) to circulate through the power distribution unit 208. The power device 200 further includes a second divider 220b extending between at least a portion of the power distribution unit 208 and at least a portion of the first power supply 206. Together, the second fan module 218b and the second divider 220b direct air that has circulated through the power distribution unit 208 away from the first power supply 206 to exit directly through the back panel 201b, as shown by arrow 229. This way, the air circulating through the first power supply 206 is the cooler ambient air (as shown by arrows 226 and 228), not the warmer air that has circulated through the power distribution unit 208 (as shown by arrow 229).

FIG. 2B illustrates an exemplary front panel 201a of the power device 200, in accordance with some examples. The front panel 201a exposes the plurality of power ports 204, one or more transceiver ports 230, and one or more audio output ports 232 for outputting output data signals (e.g., decoded and amplified audio signals). Referring back to FIG. 2A, each of the power distribution unit 208, the transceiver 210, and the audio amplifier 212 is disposed directly adjacent to the front panel 201a. Accordingly, no extra wiring is needed to connect the power distribution unit 208 (which is directly adjacent to the front panel 201a) with the plurality of power ports 204 (which are exposed on the front panel 201a), to connect the transceiver 210 (which is directly adjacent to the front panel 201a) with the one or more transceiver ports 230 (which are exposed on the front panel 201a), or to connect the amplifier 212 (which is directly adjacent to the front panel 201a) with the one or more audio output ports 232 (which are exposed on the front panel 201a). The configuration allows for easier manufacturing and avoids any interference or noise that may otherwise be introduced by the extra wiring. The front panel 201a further includes a plurality of air vents 234 for drawing in ambient air and a switch 236 for turning on/off the power device 200.

FIG. 2C illustrates an exemplary back panel 201b of the power device 200, in accordance with some examples. The back panel 201b includes a plurality of air vents 240 for outputting air that has circulated through the various components of the power device 200 for heat dissipation, as described above. The back panel 201b further includes the power inlet 203. In some examples, the location of the power inlet 203 on the back panel 201b is standardized across multiple devices. These multiple devices can be stacked on the IT rack and the standardized locations of the power inlets on the multiple devices can facilitate the installation process.

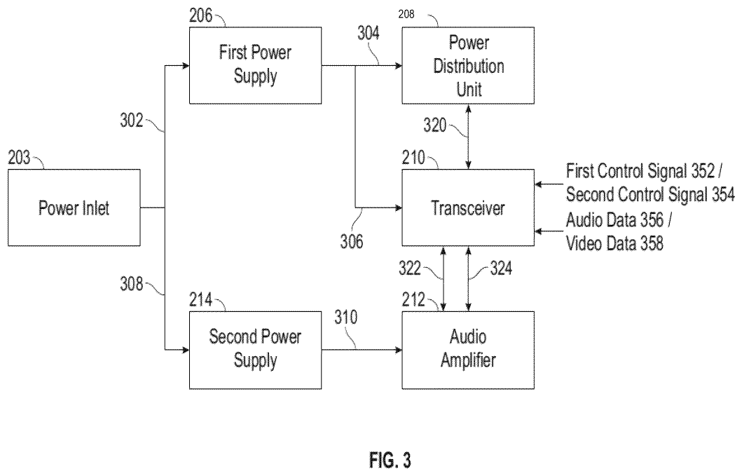

FIG. 3 illustrates an exemplary diagram showing transmission of electric power and data by the power device 200, in accordance with some examples. As discussed above with reference to FIG. 2A, the power device 200 includes the power inlet 203. The power inlet 203 can be connected to a power source (e.g., a power outlet) to receive electric power, for example, via a cable. In some examples, the power inlet 203 is an AC inlet that can be connected to the power source via an external AC power cord to receive AC power.

In FIG. 3, arrows 302-310 indicate the transmission of electric power. As shown by arrow 302, the first power supply 206 can receive electric power (e.g., AC power) from the power inlet 203. In some examples, the first power supply 206 is an AC/DC power supply that converts the incoming AC power to a stable DC power output. In the depicted example, the first power supply 206 can provide electric power to the power distribution unit 208 (as shown by arrow 304) and to the transceiver 210 (as shown by the arrow 306). In an alternative example, the transceiver 210 may be powered by the second power supply 214. In some examples, the first power supply 206 can provide DC power to the power distribution unit 208 and the transceiver 210. As shown by arrow 308, the second power supply 214 can receive electric power (e.g., AC power) from the power inlet 203. In some examples, the second power supply 214 is an AC/DC power supply that converts the incoming AC power to a stable DC power output to be used by the audio amplifier 212, as shown by arrow 310.

As discussed above with reference to FIG. 2, the transceiver 210 is configurable to operate as an encoder, as a decoder, or as an encoder and a decoder simultaneously. In some examples, the transceiver 210 can be configurable to encode a first plurality of data (e.g., video data 358 such as surgical video data) associated with the surgical environment. The first plurality of data can be provided, for example, by a camera connected to the power device 200 wirelessly or via a cable. After encoding the first plurality of data, the transceiver 210 can transmit the encoded first plurality of data over the network. Additionally or alternatively, the transceiver can be configurable to receive and decode a second plurality of data (e.g., audio data 356) associated with the surgical environment. As shown by the bi-directional arrow 324, the decoded audio data can be provided to the audio amplifier 212 for amplification, and the decoded and amplified audio data can be outputted (e.g., by at least one speaker). In other examples, the amplified audio data may be sent back to the transceiver to be encoded and transmitted (e.g., to one or more wireless speakers disposed throughout the medical environment).

In some examples, the transceiver 210 is a data-over-IP transceiver (i.e., a device that transports data in accordance with Internet Protocols or IP). In some examples, the transceiver 210 can be an Software Defined Video over Ethernet (SDVoE) transceiver. The SDVoE transceiver is configurable to encode and/or decode data (e.g., audio data, video data) for transport over a network channel (e.g., Ethernet). When operating as an encoder, the SDVoE transceiver encodes industry-standard video or multimedia signals to IP packets for network transport and distribution. When operating as a decoder, the SDVoE transceiver performs the decode function from IP packets to industry-standard multimedia signals. The SDVoE transceiver can provide both encode and decode functions simultaneously. The SDVoE transceiver allows for the use of standard network equipment (e.g., switches) for multimedia routing and distribution. In some examples, the transceiver 210 comprises one or more Field Programmable Gate Array (FPGA) devices. In some examples, the transceiver 210 comprises one or more Application Specific Integrated Circuit (ASIC) devices.

The power device 200 further includes several communication links 320 and 322 to allow the transceiver 210 to send control signals to the power distribution unit 208 and/or to the audio amplifier 212. With reference to FIG. 3, a first communication link 320 is present between the transceiver 210 and the power distribution unit 208. The transceiver 210 can be configured to receive a first control signal 352 for the power distribution unit 208 (e.g., a control signal for controlling a microprocessor or microcontroller of the power distribution unit 208). The first control signal 352 can be received over a communication network, such as a wireless network. Examples of the first control signal 352 can include: turning on/off the power distribution unit 208, resetting the power distribution unit 208, resetting one of a plurality of power ports 204, reading voltage levels at the power distribution unit 208, or the like. The transceiver 210 can provide the first control signal 352 to the power distribution unit 208 via the first communication link 320. In some examples, the first communication link 320 operates in accordance with a serial communication protocol, such as the I²C Protocol. In some examples, the first communication link 320 operates in accordance with a serial communication protocol, such as the SPI Protocol. The first communication link 320 can be bi-directional such that data can be transmitted from the power distribution unit 208 to the transceiver 210.

Further, a second communication link 322 is present between the transceiver 210 and the audio amplifier 212. The transceiver 210 can be configured to receive a second control signal 354 for the audio amplifier 212. The second control signal 354 can be received over a communication network, such as a wireless network. Examples of the second control signal 354 can include: changing the volume of the output audio signal, muting the output audio signal, changing the balance between audio stereo channels, changing settings of the audio amplifier 212 (e.g., gain settings), or the like. The transceiver 210 can provide the second control signal 354 to the audio amplifier 212 via the second communication link 322. In some examples, the second communication link 322 operates in accordance with a serial communication protocol, such as the I²C Protocol. In some examples, the second communication link 322 operates in accordance with a serial communication protocol, such as the SPI Protocol. The second communication link 322 can be bi-directional such that data can be transmitted from the audio amplifier 212 to the transceiver 210.

Accordingly, the transceiver 210 allows the user to configure and/or control the various components of the power device 200, such as the power distribution unit 208 and the audio amplifier 212, remotely through a communication network. In some examples, the user can input one or more user commands for the various components of the power device 200 via a central device and the central device can transmit control signals to the transceiver 210 accordingly. In some examples, the central device may be in an easier-to-access location than the power device 200. In some examples, the central device is located outside the surgical environment and the user can use the central device to configure and/or control the power device 200 (e.g., in the surgical environment) remotely.

In some examples, an exemplary power device for providing electric power to a plurality of electronic devices in a surgical environment, such as the power device 200 in FIGS. 2A-C, can provide a robust mechanism for managing momentary short circuit(s) detected at one of the power ports of the power device (e.g., the plurality of power ports 204). A robust mechanism for managing momentary short circuit(s) can be advantageous, for example, during the installation process. During the installation process, a user can connect an electronic device in the surgical environment with a power port of the power device using a cable. Because the cable is of a standardized length, the user may connect one end of the cable with a power port, take the other end to the electronic device to be connected, and then cut off a portion at the other end of the cable depending on the distance between the power device and the electronic device to be connected. However, when the user cuts the cable and inserts the cut end of the cable into a connector for connecting to the electronic device, the user may have already improperly turned on the power device. The conducting wires of the cable at the cut end may accidentally touch, thus creating a momentary short circuit. The momentary short circuit can usually be quickly resolved by the user as the user connects the cut end of the cable properly with the connector.

Without a robust mechanism for managing momentary short circuit(s), any short circuit detected at a power port of the power device would automatically disable or turn off the power port and/or the power device. The user then would have to return to the IT rack on which the power device is located and manually re-enable or turn on the power port and/or the power device. This is a cumbersome process, especially because the user may need to go back and forth between the electronic devices in the surgical environment and the power device (which may or may not be located in the surgical environment) as he or she connects the electronic devices in the surgical environment one-by-one.

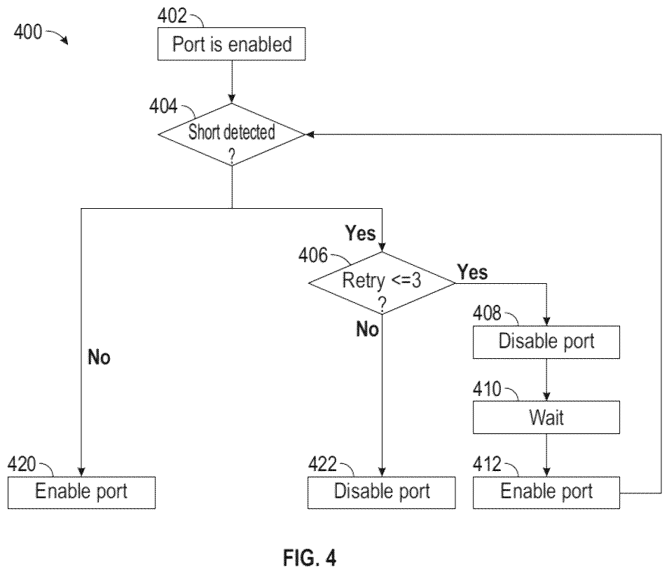

FIG. 4 illustrates an exemplary process 400 for detecting and responding to a short circuit, in accordance with some examples. The process 400 may be performed by a power distribution unit (e.g., power distribution unit 208 in FIGS. 2A-C). More specifically, the process 400 may be performed by a microcontroller of the power distribution unit. At block 402, an exemplary system (e.g., a power distribution unit) enables a power port. The power port can be one of a plurality of power ports (e.g., the plurality of power ports 204 in FIG. 2A) of the power distribution unit. At block 404, the system checks the enabled power port to determine whether a short circuit has occurred at the enabled power port. If the system determines that no short circuit has been detected at block 404, the port stays enabled at block 420 and the process 400 terminates.

However, if a short circuit has been detected at block 404, the system determines if the short circuit is a momentary short circuit. To determine whether the short circuit is a momentary short circuit, the system disables the power port for a predetermined period of time and then re-enables the power port to check if the short circuit is still present at the power port. The system can perform multiple rounds of retries until a predefined number of retries has been exceeded. When the predefined number of retries has been exceeded, the system determines that the short circuit is not momentary and thus disables the power port to protect the power device.

Specifically with reference to FIG. 4, the system determines if the system has exceeded a predefined number of retries at block 406. In the depicted example, the predefined number is 3. If the system has not exceeded the predefined number of retries, the system performs a retry by disabling the port at block 408, waiting for a predefined time period at block 410, and enabling the port again at block 412. In some examples, the predefined time period can be 1 second, 2 seconds, 3 seconds, . . . 10 seconds, or the like. In some examples, the predefined time period can be between 2-5 seconds. The system then returns to block 404 to determine whether the short circuit is still detected at the enabled power port. If the short circuit is still detected at the enabled power unit, the system can perform additional rounds of retries (i.e., blocks 408-412) until the predefined number of retries is exceeded. If the predefined number of retries is exceeded at block 406, the system disables the port at block 422 because it determines that the short circuit is not a momentary short circuit and may be caused by a fault condition. In some examples, the predefined number of retries can be configurable by a user.

In some examples, the system can use the process 400 to manage any detected short circuit (e.g., during power up, during steady state operation). In some examples, the predefined time period and/or the predefined number of retries are configurable by a user (e.g., using a microprocessor or microcontroller of the power device).

As discussed herein, the power device can include a microcontroller that can manage various components and processes at the power device (e.g., turning on/off power ports, managing momentary short circuits as discussed above). However, the microcontroller introduces a point of failure because a failed boot of the microcontroller may affect the operation of the power ports of the power device. The power device needs to provide a fail-safe mechanism to ensure that the power ports are operational (e.g., providing power) even in the event of a boot failure of the microcontroller. Specifically, because the power device provides power to critical devices (e.g., cameras, displays, surgical tools) in a surgical environment, the power device needs to continue providing electric power even in the event of a boot failure of the microcontroller to ensure patient safety.

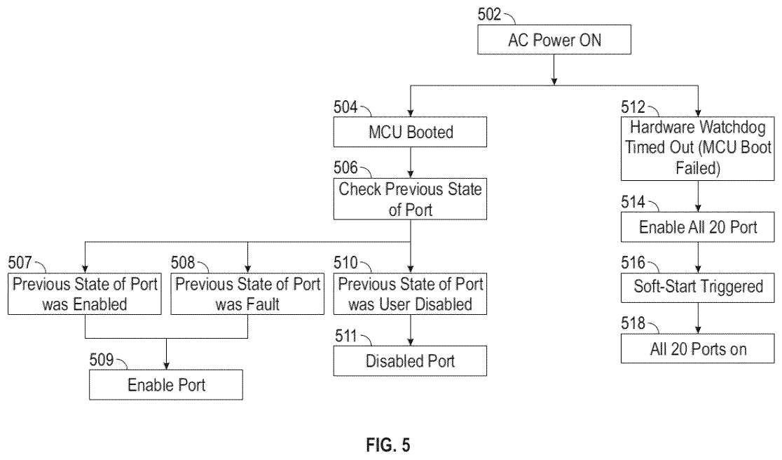

FIG. 5 illustrates an exemplary startup process of the power device. At block 502, a power device (e.g., the power device 200 in FIGS. 2A-C) is powered on. Upon receiving power at the block 502, the power device attempts to boot the microcontroller. At block 512, the power device detects a failed boot of the microcontroller. The failed boot of the microcontroller can be detected, for example, by detecting that a corresponding hardware watchdog timer has timed out. At block 514, the power device automatically enables the plurality of power ports (e.g., the plurality of power ports 204). In some examples, the plurality of power ports are automatically enabled via a one-shot circuit (i.e., monostable multivibrator). At block 516, the power device triggers a soft-start process for ramping up the power relatively slowly and the plurality of power ports are on at block 518. This way, while the additional functionalities of the microcontroller are not available (e.g., the process 400 for managing momentary short circuits), the power ports can still provide power to electronic devices in the surgical environment to ensure that the surgical environment is functional.

Alternatively, at block 504, the power device detects that the microcontroller has been successfully booted and can take over control of the power ports. Accordingly, the power device can enable the plurality of power ports based on a previous state of each port of the plurality of power ports. The previous state of each port can be read from a memory unit of the power device and can indicate whether the port was previously set to be “Enabled or “User Disabled.” For example, a user may have disabled one or more of the plurality of power ports that were not in use to save power, decrease the operating temperature of the power device, and/or increase the efficiency of the power device. Accordingly, if the previous state of the port was “Enabled” in block 507, the power device can enable the power port in block 509; if the previous state of the port was “User Disabled” in block 510, the power device can disable the power port in block 511. Preserving the previous state minimizes the need to reconfigure the power device and saves installation time. In some examples, the previous state of the power port is “Fault” (indicating a faulty condition occurred in the previous use) as shown in block 508, and the power device can clear the “Fault” state and enable the power port in block 509.

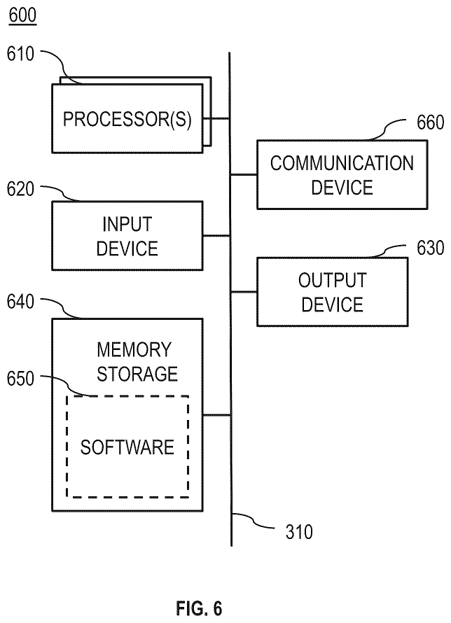

FIG. 6 illustrates an example of a computing device in accordance with one example. The operations described above with reference to FIGS. 1-5 are optionally implemented by components depicted in FIG. 6. Device 600 can be a host computer connected to a network. Device 600 can be a client computer or a server. As shown in FIG. 6, device 600 can be any suitable type of microprocessor-based device, such as a personal computer, workstation, server or handheld computing device (portable electronic device) such as a phone or tablet. The device can include, for example, one or more of processor 610, input device 620, output device 630, storage 640, and communication device 660. Input device 620 and output device 630 can generally correspond to those described above, and can either be connectable or integrated with the computer.

Input device 620 can be any suitable device that provides input, such as a touch screen, keyboard or keypad, mouse, or voice-recognition device. Output device 630 can be any suitable device that provides output, such as a touch screen, haptics device, or speaker.

Storage 640 can be any suitable device that provides storage, such as an electrical, magnetic or optical memory including a RAM, cache, hard drive, or removable storage disk. Communication device 660 can include any suitable device capable of transmitting and receiving signals over a network, such as a network interface chip or device. The components of the computer can be connected in any suitable manner, such as via a physical bus or wirelessly.

Software 650, which can be stored in storage 640 and executed by processor 610, can include, for example, the programming that embodies the functionality of the present disclosure (e.g., as embodied in the devices as described above).

Software 650 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 640, that can contain or store programming for use by or in connection with an instruction execution system, apparatus, or device.

Software 650 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

Device 600 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T6 or T6 lines, cable networks, DSL, or telephone lines.

Device 600 can implement any operating system suitable for operating on the network. Software 650 can be written in any suitable programming language, such as C, C++, Java or Python. In various examples, application software embodying the functionality of the present disclosure can be deployed in different configurations, such as in a client/server arrangement or through a Web browser as a Web-based application or Web service, for example.

The foregoing description, for the purpose of explanation, has been described with reference to specific examples or aspects. However, the illustrative discussions above are not intended to be exhaustive or to limit the invention to the precise forms disclosed. For the purpose of clarity and a concise description, features are described herein as part of the same or separate variations; however, it will be appreciated that the scope of the disclosure includes variations having combinations of all or some of the features described. Many modifications and variations are possible in view of the above teachings. The variations were chosen and described in order to best explain the principles of the techniques and their practical applications. Others skilled in the art are thereby enabled to best utilize the techniques and various variations with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

For the purpose of clarity and a concise description, features are described herein as part of the same or separate examples; however, it will be appreciated that the scope of the disclosure includes examples having combinations of all or some of the features described.

What is claimed is:

1. A device for providing power to a plurality of electronic devices in a surgical environment and for processing multimedia data associated with the surgical environment, comprising:
a housing;
a plurality of ports exposed on the housing, each port connectable to an electronic device of the plurality of electronic devices in the surgical environment;
a first power unit enclosed in the housing, the first power unit comprising a first power supply and a power distribution unit, wherein the power distribution unit is configured to receive power from the first power supply and distribute the power across the plurality of ports;
an audio output port exposed on the housing;
a transceiver enclosed in the housing, wherein the transceiver is configured to receive and decode an audio signal associated with the surgical environment;
an audio amplifier enclosed in the housing, wherein the audio amplifier is configured to amplify the decoded audio signal and output the decoded and amplified audio signal via the audio output port; and
a second power unit enclosed in the housing, wherein the second power unit is different from the first power unit and is configured to power the audio amplifier.

2. The device of claim 1, wherein the plurality of electronic devices in the surgical environment comprise: one or more cameras, one or more medical devices, one or more surgical tools, one or more displays, one or more speakers, one or more input devices, one or more video or audio encoders, one or more video or audio decoders, one or more transceivers, or any combination thereof.

3. The device of claim 1, further comprising a first divider enclosed in the housing,
wherein the first divider extends from a side panel of the housing to a back panel of the housing to form a compartment, and
wherein the first power unit is disposed outside the compartment and the second power unit is disposed inside the compartment.

4. The device of claim 3, wherein the first divider is configured to direct a first air flow to enter from the front panel of the housing, to circulate through the second power unit disposed inside the compartment, and to exit through the back panel of the housing.

5. The device of claim 4, wherein the first divider is configured to direct a second air flow to enter from a front panel of the housing, to circulate through the first power unit disposed outside the compartment, and to exit through the back panel of the housing.

6. The device of claim 5, wherein the first divider is configured to provide Electromagnetic Radiation (EMR) insulation between the first power unit and the second power unit.

7. The device of claim 1, further comprising a second divider enclosed in the housing, wherein the second divider extends between at least a portion of the power distribution unit and at least a portion of the first power supply to direct air circulating through the power distribution unit away from the first power supply.

8. The device of claim 1, wherein the transceiver is configurable to: encode and transmit a first plurality of data associated with the surgical environment; and
receive and decode a second plurality of data associated with the surgical environment.

9. The device of claim 1, wherein the second power unit is dedicated to provide power to the audio amplifier.

10. The device of claim 1, further comprising a first communication link between the transceiver and the first power unit.

11. The device of claim 10, wherein the transceiver is configured to receive a first control signal for the first power unit and provide the first control signal for the first power unit to the first power unit via the first communication link.

12. The device of claim 1, further comprising a second communication link between the transceiver and the audio amplifier.

13. The device of claim 12, wherein the transceiver is configured to receive a second control signal for the audio amplifier and provide the second control signal for the audio amplifier to the audio amplifier via the second communication link.

14. The device of claim 1, wherein the first power unit is further configured to:
(a) detect a short circuit at a port of the plurality of ports;
(b) upon detecting the short circuit, disable the port for a predefined time period; and
(c) enable the port after the predefined time period.

15. The device of claim 14, wherein the first power unit is further configured to:
repeat steps (a)-(c) for a predefined number of iterations; and
disable the port if the short circuit is detected at the port in each iteration of the predefined number of iterations.

16. The device of claim 1, wherein the first power unit comprises a microcontroller and is further configured to:
upon receiving power, boot the microcontroller;
identify a failed boot of the microcontroller; and
automatically enable the plurality of ports.

17. The device of claim 16, wherein the plurality of ports are automatically enabled via a one-shot circuit.

18. The device of claim 16, wherein the first power unit is further configured to:
identify a successful boot of the microcontroller, and enable the plurality of ports based on a previous state of each port of the plurality of ports.

19. A method for providing power to a plurality of electronic devices in a surgical environment and for processing multimedia data associated with the surgical environment, comprising:
at a power device:
receiving, by a power distribution unit enclosed in a housing of the power device, power from a first power supply enclosed in the housing of the power device;
distributing, by the power distribution unit, the power across a plurality of ports exposed on the housing, wherein each port of the plurality of ports is connectable to an electronic device of the plurality of electronic devices in the surgical environment;
receiving and decoding, by a transceiver enclosed in the housing, an audio signal associated with the surgical environment;
amplifying, by an audio amplifier enclosed in the housing and powered by a second power supply different from the first power supply, the decoded audio signal;
outputting the decoded and amplified audio signal via an audio output port exposed on the housing of the power device.

20. A non-transitory computer-readable storage medium storing one or more programs for providing power to a plurality of electronic devices in a surgical environment and for processing multimedia data associated with the surgical environment, the one or more programs comprising instructions, which when executed by one or more processors of a power device, cause the power device to:
receive, by a power distribution unit enclosed in a housing of the power device, power from a first power supply enclosed in the housing of the power device;
distribute, by the power distribution unit, the power across a plurality of ports exposed on the housing, wherein each port of the plurality of ports is connectable to an electronic device of the plurality of electronic devices in the surgical environment;
receive and decode, by a transceiver enclosed in the housing, an audio signal associated with the surgical environment;
amplify, by an audio amplifier enclosed in the housing and powered by a second power supply different from the first power supply, the decoded audio signal;
output the decoded and amplified audio signal via an audio output port exposed on the housing of the power device.
